(19) United States
(12) Patent Application Publication
(10) Pub. No.: US 2015/0112861 A1
(43) Pub. Date: Apr. 23, 2015

(54) METHOD FOR COMPUTERIZING A RECEIPT

(71) Applicant: CyberSoft Digital Services Corp., Taipei City (TW)

(72) Inventors: Chien-Min YU, Taipei City (TW); Hui-Min FANG, Taipei City (TW); Chiu-Wang LIN, Taipei City (TW); Ching-Hsien CHUANG, Taipei City (TW)

(73) Assignee: CyberSoft Digital Services Corp., Taipei City (TW)

(21) Appl. No.: 14/201,448

(22) Filed: Mar. 7, 2014

(30) Foreign Application Priority Data
Oct. 23, 2013 (TW) 102138307

(51) Int. Cl. G06Q 20/04; G06Q 20/40

(52) U.S. Cl. CPC G06Q 20/0453; G06Q 20/40145
USPC 705/44

(57) ABSTRACT

A method for computerizing a receipt is applied to an electronic device with a touch screen, and the method includes retrieving a plurality of trading data of a trade, computing a characteristic code according to the trading data, and displaying a signature-field pattern with the computed characteristic code on the touch screen.

### CROSS-REFERENCES TO RELATED APPLICATIONS

This non-provisional application claims priority under 35 U.S.C. §119(a) on Patent Application No. 102138307 filed in Taiwan, R.O.C. on Oct. 23, 2013, the entire contents of which are hereby incorporated by reference.

### FIELD

The invention relates to an implementing method of electronic signatures, and particularly to a method for computerizing a receipt.

### BACKGROUND

Along with the blooming of business activities, the volume of deal-on-credit has increased. Due to convenience, most consumers purchase goods using credit cards or other plastic tokens, and the deal-on-credit trading mode has become the major trading mode.

The trading procedure of a credit card is described as follows. Firstly, the clerk uses the cashier to calculate the total transaction amount; then, the clerk must slide the consumer's credit card on the card reader (or insert the credit card into the card reader), before the cashier prints the receipt (or after the cashier prints the receipt), to allow the card reader reading the card number, the expiry date or other recognizing data of the credit card and to input the total transaction amount to the card reader manually; then, after finishing the credit card authentication, the financial authorizing institute will send an effective authorized code to the card reader, so that the card reader can print the receipt for the consumer to sign their name.

However, this method is highly vulnerable to credit card fraud, since the credit card data can easily be leaked or illegally recorded; additionally, the signature of the credit card holder cannot be recognized immediately. Furthermore, the receipt printed by the conventional card reader soils easily and is difficult to store, and it is inconvenient for the credit card holder to check receipt details.

### SUMMARY

In one embodiment, a method for computerizing a receipt is applied to an electronic device with a touch screen, and the method includes retrieving a plurality of trading data related to a trade, computing a characteristic code based on the trading data, and displaying a signature-field pattern with the characteristic code on the touch screen.

As mentioned previously, when the method for computerizing a receipt of the present invention is applied to the electronic device with the touch screen, a specific signature-field pattern is provided for each trade, so as to avoid embezzlement of the computerized signature for other uses, thereby increasing the usage of the computerized signature.

The detailed features and advantages of the disclosure are described below in great detail through the following embodiments, the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only and thus not limitative of the disclosure, wherein:

FIG. 1 is a block diagram of an embodiment of an electronic device performing a method for computerizing a receipt;

FIG. 2 is a schematic view of the electronic device shown in FIG. 1;

FIG. 3 is a flow chart of an embodiment of the method for computerizing a receipt;

FIG. 4 is a schematic view of an embodiment of a signature image; and

FIG. 5 is a flow chart of an embodiment of Step 470.

### DETAILED DESCRIPTION

The method for computerizing a receipt according to the present invention is adapted to a trade in which the signature of the consumer is needed. The method for computerizing a receipt is implemented in an electronic device with a touch screen through executing hardware or soft algorithms by a processing unit of the electronic device. In some embodiments, the electronic device is a portable electronic device.

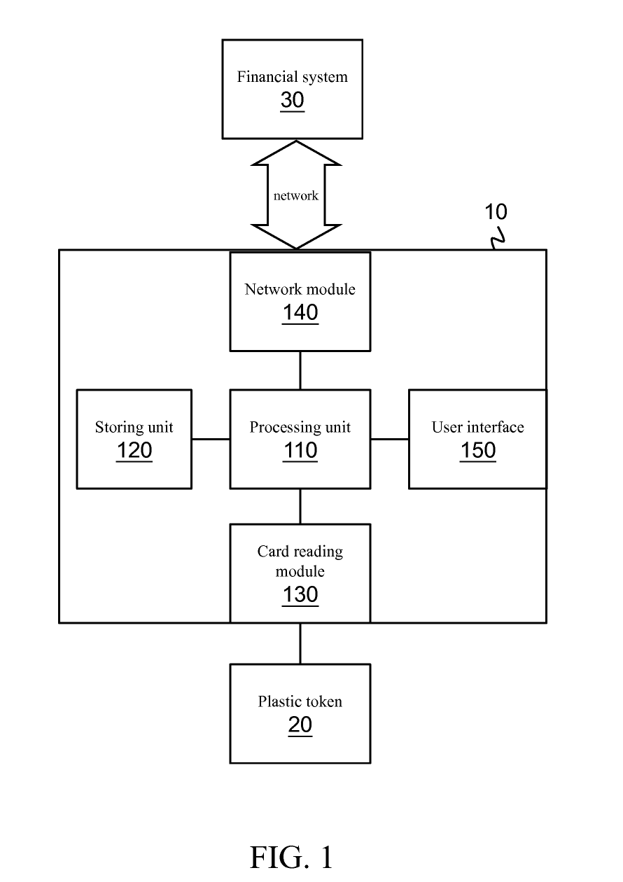

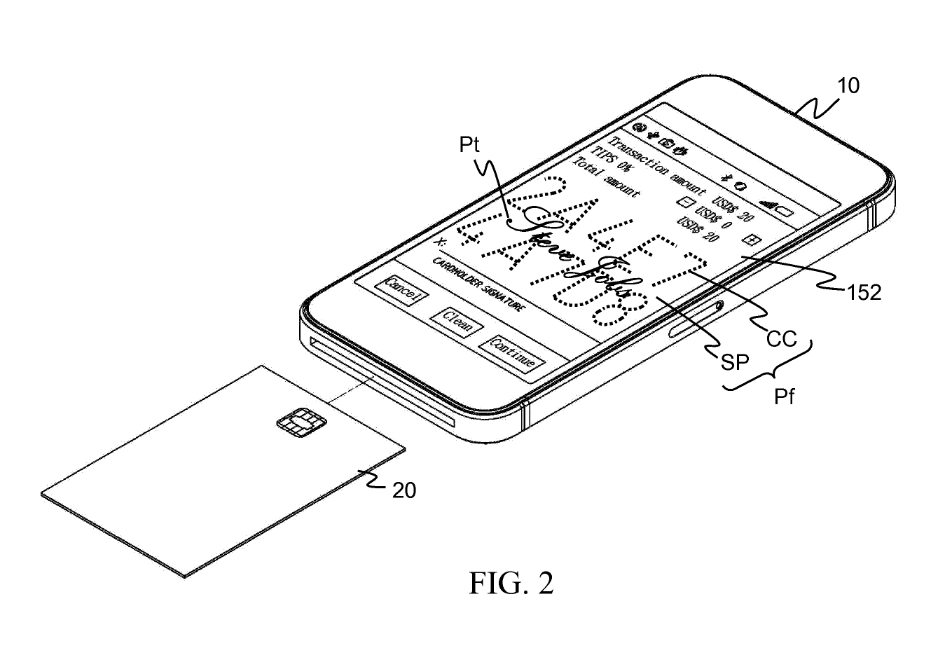

Please referring to FIG. 1 and FIG. 2, the electronic device 10, where the method for computerizing a receipt is applied, includes a processing unit 110, a storing unit 120, a card reading module 130, a network module 140 and a user interface 150. Here, the user interface 150 can be the touch screen 152, or can be the combination of the touch screen 152 and one or more solid-state buttons (not shown).

The processing unit 110 is electrically connected to the storing unit 120, the card reading module 130, the network module 140 and the touch screen 152, and the processing unit 110 controls the operations of the aforementioned components. The network module 140 communicates with a financial system 30 via wireless network or communication network.

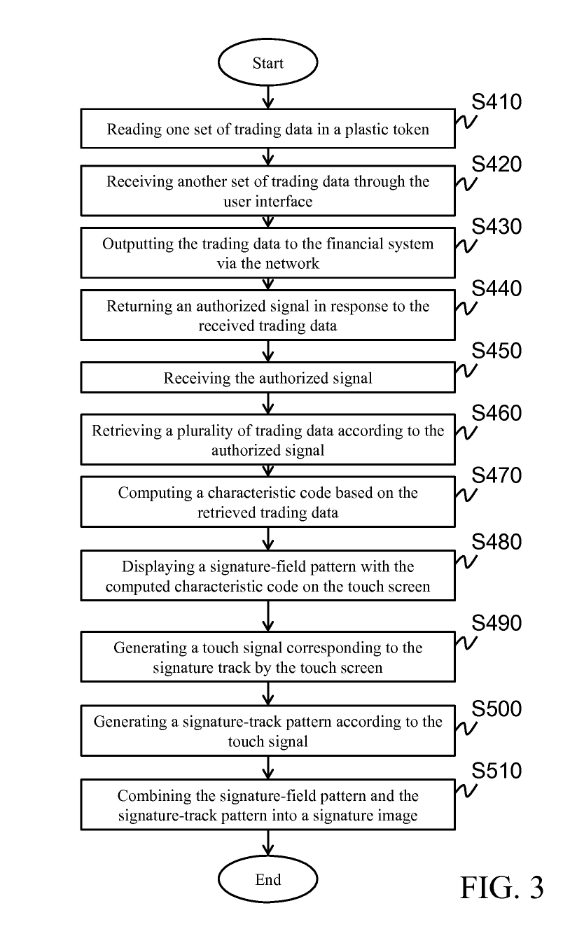

Please referring to FIGS. 1-2 and FIG. 3, when processing a trade, the processing unit 110 reads one set of trading data (hereinafter, called the first trading data) in a plastic token 20 through the card reading module 130 (step S410), and temporarily stores the read first trading data in the storing unit 120.

The processing unit 110 further receives another set of trading data (hereinafter, called the second trading data), through the user interface 150 (step S420), and temporarily stores the read second data in the storing unit 120. The first trading data can be the primary account number (PAN), the expiry date of the plastic token, or so forth. The second trading data can be the transaction amount, the identification code of the goods, the number of the goods or so forth.

The processing unit 110 wirelessly outputs the first trading data and the second trading data to the network through the network module 140 so as to send the first trading data and the second trading data to the remote financial system 30 via the network (step S430). In some embodiments, the processing unit 110 can output the whole or parts of the first trading data and the whole or parts of the second trading data. For example, the processing unit 110 sends the primary account number and the transaction amount to the financial system 30 via the network.

The financial system 30 returns an authorized signal in response to the received trading data (that is, the first trading data and the second trading data), (step S440). In some embodiments, the financial system 30 processes an identity authentication according to the received first trading data and the received second trading data. After the identity authentication is finished, the financial system 30 returns the authorized signal representing that the identity authentication is successful.

The processing unit 110 receives the authorized signal via the network through the network module 140 (step S450), and retrieves a plurality of trading data (hereinafter, called third trading data), from the storing unit 120 and/or other programs according to the authorized signal (step S460). Here, the third trading data can be the primary account number, the processing code, the transaction amount, the system trace number, the transaction date, the transaction time, the card acceptor terminal identification, the card acceptor identification code, the invoice number, etc. In other words, the third trading data can be the information related to this trade stored in the storing unit 120 upon the trade is processing, or be the executing results related to the trade of other programs.

The processing unit 110 computes a characteristic code CC based on the retrieved third trading data (step S470). Then, the processing unit 110 displays a signature-field pattern Pf with the computed characteristic code CC on the touch screen 152 (step S480), so that the holder of the plastic token 20 can sign on the signature-field pattern Pf for ensuring the trade. Here, the signature-field pattern Pf has a signing space SP, and the characteristic code CC is the background image of the signing space SP.

The touch screen 152 detects the signature track Ts occurred on the displayed signature-field pattern Pf and generates a touch signal corresponding to the signature track Ts (step S490).

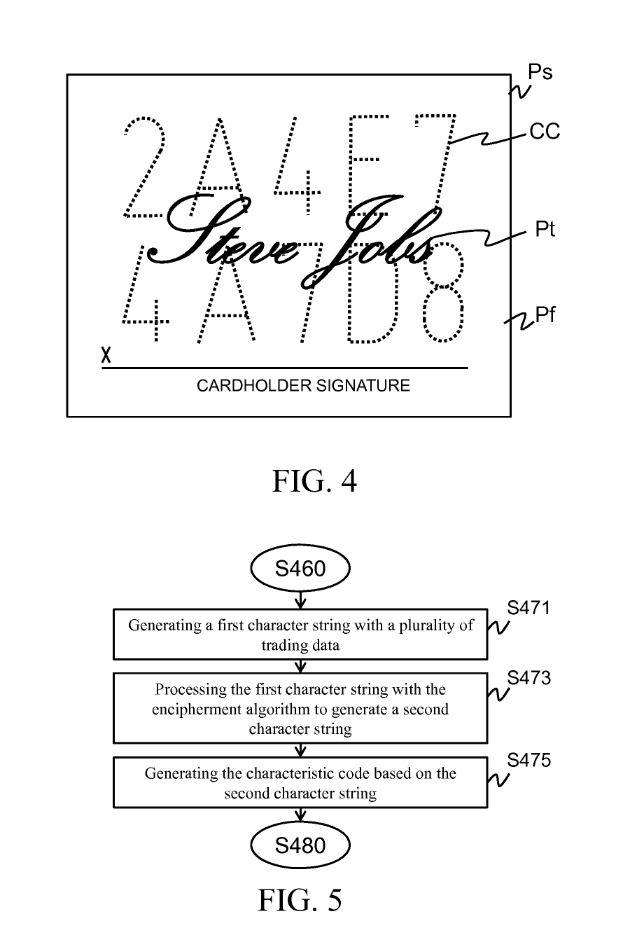

The processing unit 110 generates a signature-track pattern Pt according to the touch signal (step S500), and combines the signature-field pattern Pf and the signature-track pattern Pt into a signature image Ps, as shown in FIG. 4 (step S510).

In some embodiments, the processing unit 110 can store the signature image Ps in the store unit 120 for the billing to the financial institutes later. In addition, the processing unit 110 can send the signature image Ps and preliminary trading data to the financial system 30 of the financial institutes via the network through the network module 140 for ensuring the payment and for the billing. The preliminary trading data can be the whole combination or any combination of the primary account number, the processing code, the transaction amount, the system trace number, the transaction date, the transaction time, the card acceptor terminal identification, the card acceptor identification code, the invoice number or so forth.

The processing unit 110 can include one or more various processers. The storing unit 120 includes one or more various memories, such as read only memory, flash memory, random access memory, hard disk, micro memory, etc. The card reading module 130 can be a contact type card reader or a noncontact type card reader. The network module 140 can be a wireless network module, a communication network module or the combination thereof. The plastic token 20 can be the credit card, the stored-value card, the debit card, the easycard, the Kaohsiung rapid transit card, the smart card or other tokens for the consumption. The characteristic code CC is a character string composed of letters of any language, the number, the sign or the combination thereof. Here, the characteristic code CC is a 5-to-14-bits character string.

Taking trading via the credit card as an example, after receiving the authorized signal, referring to FIG. 5, the processing unit 110 retrieves the system trace number, the transaction date, the card acceptor terminal identification, the card acceptor identification code and the invoice number to generate a character string (hereinafter, called the first character string) (step S471).

Supposing that the system trace number is “012345”, the transaction date is “0905”, the card acceptor terminal identification is “12345678”, the card acceptor identification code is “1234567890” and the invoice number is “123456”.

In one embodiment of step S471, the processing unit 110 combines the system trace number, the transaction date, the card acceptor terminal identification, the card acceptor identification code and the invoice number to generate the combined string in a hexadecimal (Hex) format, namely, the first character string.

Thereafter, the processing unit 110 processes the first character string with the encipherment algorithm to generate another character string (hereinafter, called the second character string) (step S473). The encipherment algorithm can be cipher-block chaining (CBC) mode algorithm, propagating cipher-block chaining (PCBC) mode algorithm, cipher feedback mode (CFB mode) algorithm, output feedback (OFB) mode algorithm, counter mode (CM) algorithm, a data encryption standard (DES) algorithm, Ron Rivest, Adi Shamir and Leonard Adleman (RSA) algorithm or the combination thereof.

In one embodiment of step S473, the processing unit 110 can process the encryption by taking a predefined number of bits as one unit of the character string. For example, the processing unit 110 encrypts the first character string to generate the second character string by taking 8 bits as one unit.

Thereby, the processing unit 110 generates the characteristic code CC based on the second character string (step S475). In one embodiment of the step S475, the processing unit 110 takes any number of bits of the second character string as the characteristic code CC. For example, the processing unit 110 takes the first ten bits, the last twelve bits or the odd bits of the second character string as the characteristic code CC, but not limited thereto. In some embodiments, the processing unit 110 directly takes the whole second character string as the characteristic code CC.

Then, the processing unit 110 distributes the characteristic code CC in a matrix or in any line on the signing space SP to generate the signature-field pattern Pf.

As mentioned previously, when the method for computerizing a receipt of the present invention is applied to the electronic device 10 with the touch screen 152, a specific signature-field pattern Pf is provided for each trade so as to avoid embezzlement of the computerized signature for other uses, thereby increasing the usage of the computerized signature.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A method for computerizing a receipt, applicable to an electronic device with a touch screen, comprising:
retrieving a plurality of trading data related to a trade;
computing a characteristic code according to the trading data; and
displaying a signature-field pattern with the computed characteristic code on the touch screen.

2. The method for computerizing a receipt according to claim 1, further comprising:
wirelessly outputting the trading data; and
receiving a returned authorized signal corresponding to the trading data;
wherein the computing step comprises computing a characteristic code with trading data according to the authorized signal.

3. The method for computerizing a receipt according to claim 2, further comprising
generating a touch signal corresponding to the signature track occurred on the displayed signature-field pattern by the touch screen;
generating a signature-track pattern according to the touch signal; and
combining the signature-field pattern and the signature-track pattern into a signature image.

4. The method for computerizing a receipt according to claim 1, further comprising:
generating a touch signal corresponding to the signature track occurred on the signature-field pattern by the touch screen;
generating a signature-track pattern according to the touch signal; and
combining the signature-field pattern and the signature-track pattern into a signature image.

5. The method for computerizing a receipt according to claim 1, wherein the computing step comprise:
generating a character string based on the trading data; and
processing the character string with an encipherment algorithm to generate the characteristic code.

6. The method for computerizing a receipt according to claim 1, wherein the computing step comprise:
generating a first character string based on the trading data; and
processing the first character string with an encipherment algorithm to generate a second character string; and
generating the characteristic code based on the second character string.

7. The method for computerizing a receipt according to claim 1, wherein the signature-field pattern has a signing space, and the characteristic code is the background image of the signing space.

8. The method for computerizing a receipt according to claim 1, wherein the characteristic code is selected from the group consisting of letters, numbers, signs and the combination thereof.

9. The method for computerizing a receipt according to claim 1, wherein the trade is processed with a plastic token.

10. The method for computerizing a receipt according to claim 1, wherein the trading data is selected from the group consisting of a primary account number of a plastic token, an expiry date of the plastic token, a processing code, a transaction amount, an identification code of goods, a number of the goods, a system trace number, a transaction date, a transaction time, a card acceptor terminal identification, a card acceptor identification code, an invoice number and the combination thereof.
